(19) United States
(12) Patent Application Publication
(10) Pub. No.: US 2003/0020948 A1
(43) Pub. Date: Jan. 30, 2003

(54) Dynamically loaded applications in a printer

(76) Inventors: Daniel Cook Jarvis, Meridian, ID (US); Daniel James Dyer, Boise, ID (US)

Correspondence Address: HEWLETT-PACKARD COMPANY, Intellectual Property Administration, P. O. Box 272400, Fort Collins, CO, 80527-2400, US

(21) Appl. No.: 09/917,493

(22) Filed: Jul. 27, 2001

(51) Int. Cl. G06F 3/12; G06F 9/00; G06F 15/16; G06F 9/445

(52) U.S. Cl. 358/1.15; 717/176; 709/200

(57) ABSTRACT

A manager loadable printer, an agent that communicates with a printer, and related methods for enhancing printer functionality.

### TECHNICAL FIELD

The present invention relates to printing devices. More particularly, the invention relates to a system that manages printers.

### BACKGROUND

Printer functionality is normally fixed during manufacture and/or at ship time. A need exists for systems and/or methods to enhance printer functionality.

### SUMMARY

A method of managing printers, an agent that communicates with a printer, and a manager that manages printers. An exemplary manager manages a printer through use of an agent wherein the agent communicates with a printer having a virtual machine installed thereon. Also disclosed is a computer-readable medium containing a computer program that is storable in memory and executable by a processor to manage, communicate with and/or configure a printer.

### BRIEF DESCRIPTION OF THE DRAWINGS

The present invention is illustrated by way of example and not limitation in the figures of the accompanying drawings. The same numbers are used throughout the figures to reference like components and/or features.

FIG. 1 illustrates a network environment in which multiple servers, workstations, and printers are coupled to one another via a data communication network.

FIG. 2 is a block diagram showing pertinent components of a printer suitable for use with various exemplary systems and/or methods described herein.

FIG. 3 is a block diagram showing pertinent components of a computer workstation suitable for use with various exemplary systems and/or methods described herein.

FIG. 4 is a block diagram showing a printer having a virtual machine (printer virtual machine) suitable for use with various systems and/or methods described herein.

FIG. 5 is a block diagram of an exemplary hierarchy between browsers, managers, agents and applets suitable for use with various systems and/or methods described herein.

FIG. 6 is a block diagram of an exemplary manager in communication with an exemplary agent suitable for use with various systems and/or methods described herein.

FIG. 7 is a block diagram of an exemplary system including a workstation or server having a manager and an agent resident thereon.

FIG. 8 is a block diagram of the exemplary system of FIG. 7 communicating an applet to a printer.

FIG. 9 is a block diagram of the exemplary system of FIGS. 7 and 8 operating and communicating.

FIG. 10 is a block diagram of an exemplary system including a workstation having a manager and a server having an agent wherein the manager directs an applet to a printer.

FIG. 11 is a block diagram of the exemplary system of FIG. 10 operating and communicating.

FIG. 12 is a block diagram of a job accounting process using a system such as a system presented in FIGS. 7-11.

### DETAILED DESCRIPTION

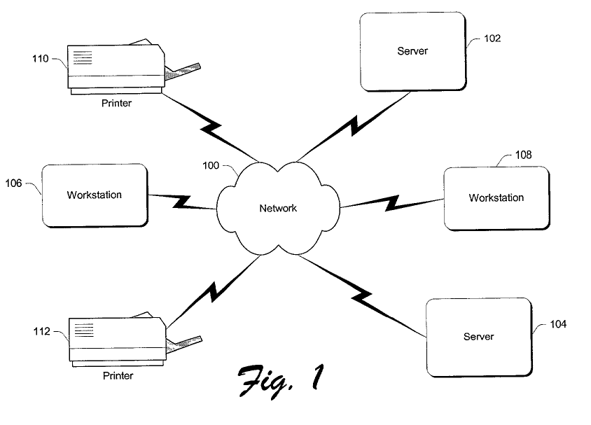

FIG. 1 illustrates a network environment in which multiple servers, workstations, and printers are coupled to one another via a data communication network 100. The network 100 couples together servers 102 and 104, computer workstations 106 and 108, and printers 110 and 112. Network 100 can be any type of network, such as a local area network (LAN) or a wide area network (WAN), using any type of network topology and any network communication protocol. In a particular embodiment, network 100 is the Internet. Although only a few devices are shown coupled to network 100, a typical network may include tens or hundreds of devices coupled to one another. Furthermore, network 100 may be coupled to one or more other networks, thereby providing coupling between a greater number of devices.

Servers 102 and 104 may be file servers, email servers, database servers, print servers, or any other type of network server. Workstations 106 and 108 can be any type of computing device, such as a personal computer. Particular embodiments of the invention illustrate printers 110 and 112 as laser printers. However, alternate embodiments of the invention are implemented with ink-jet, bubble-jet or any other type of printer. Furthermore, the teachings of the present invention may be applied to any type of printing device, such as copiers and fax machines. Although not shown in FIG. 1, one or more workstations and/or servers may contain a print rendering engine capable of converting raw print job information into a particular format (e.g., language) understood by certain types of printers.

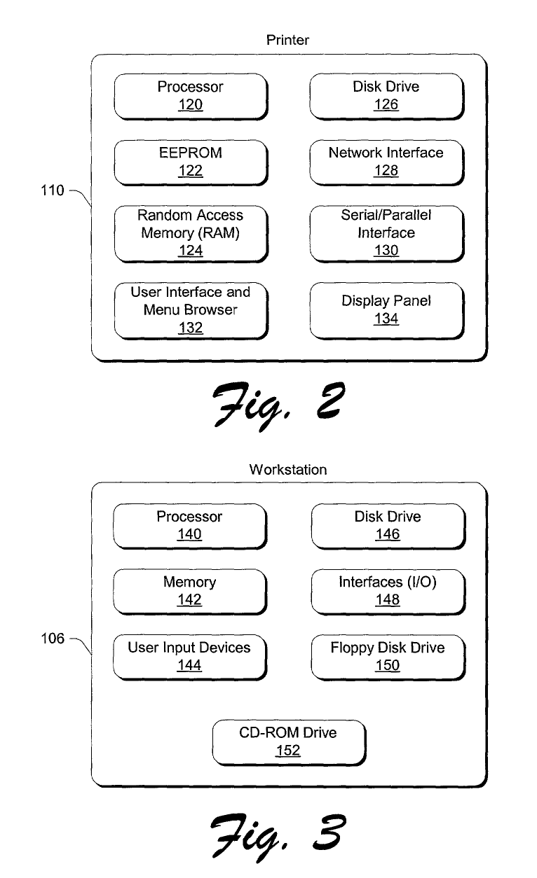

FIG. 2 is a block diagram showing pertinent components of printer 110 suitable for use with various examples presented herein. Printer 110 includes a processor 120, an electrically erasable programmable read-only memory (EEPROM) 122, and a random access memory (RAM) 124. Processor 120 processes various instructions necessary to operate the printer 110 and communicate with other devices. EEPROM 122 and RAM 124 store various information such as configuration information, fonts, templates, data being printed, and menu structure information. Although not shown in FIG. 2, a particular printer may also contain a ROM (non-erasable) in place of or in addition to EEPROM 122.

Printer 110 also includes a disk drive 126, a network interface 128, and a serial/parallel interface 130. Disk drive 126 provides additional storage for data being printed or other information used by the printer 110. Although both RAM 124 and disk drive 126 are illustrated in FIG. 2, a particular printer may contain either RAM 124 or disk drive 126, depending on the storage needs of the printer. For example, an inexpensive printer may contain a small amount of RAM 124 and no disk drive 126, thereby reducing the manufacturing cost of the printer. Network interface 128 provides a connection between printer 110 and a data communication network, such as network 100. Network interface 128 allows devices coupled to a common data communication network to send print jobs, menu data, and other information to printer 110 via the network. Similarly, serial/parallel interface 130 provides a data communication path directly between printer 110 and another device, such as a workstation, server, or other computing device. Although the printer 110 shown in FIG. 2 has two interfaces (network interface 128 and serial/parallel interface 130, which are optionally USB or wireless interfaces), a particular printer may only contain one interface.

As shown in FIG. 2, printer 110 also contains a user interface/menu browser 132 and a display panel 134. User interface 132 may be a series of buttons, switches or other indicators that are manipulated by the user of the printer. Display panel 134 is a graphical display that provides information regarding the status of the printer and the current options available through the menu structure. Thus, the user can provide input to the printer 110 by touching the appropriate portion of the touch screen.

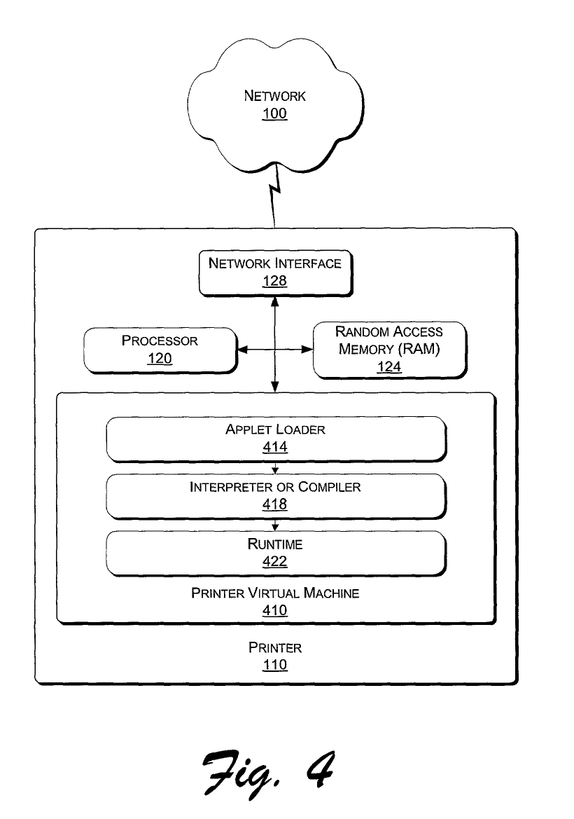

FIG. 3 is a block diagram showing pertinent components of a computer workstation 106 in accordance with the invention. Workstation 106 includes a processor 140, a memory 142 (such as ROM and RAM), user input devices 144, a disk drive 146, interfaces 148 for inputting and outputting data, a floppy disk drive 150, and a CD-ROM drive 152. Processor 140 performs various instructions to control the operation of workstation 106. Memory 142, disk drive 146, and floppy disk drive 150, and CD-ROM drive 152 provide data storage mechanisms. User input devices 144 include a keyboard, mouse, pointing device, or other mechanism for inputting information to workstation 106. Interfaces 148 provide a mechanism for workstation 106 to communicate with other devices.

Managed Printers

To improve and enhance operation of a printer, an exemplary system includes a manager, an agent, an applet and a printer having a virtual machine capable of executing the applet. The manager performs various management tasks related to one or more printers. For example, the manager may pull an agent-applet pair from a Web site and then direct the applet to a printer having a virtual machine installed thereon. In this example, the manager communicates with the agent and the agent communicates with the virtual machine. Thus, through use of the manager, a user can monitor and/or control execution of the applet on the printer's virtual machine.

The managers and associated methods described herein allow for adjustment and/or implementation of printer functionality, which has historically been fixed at manufacturing or ship time. In various exemplary systems presented herein, managed printers include support for an embedded virtual machine. Agents and/or managers provide services and/or applets to enable and support new functionality and/or adjust “ship time” functionality.

Various exemplary managers can load new or updated applications into the printer, typically in the form of printer applets. Corresponding agents allow for interaction with printer applets. Agents and applets are further updateable to maintain compatibility (i.e., version, language, printer model, etc.). Through agent and/or manager services, various systems can monitor a printer application's status and/or current state/configuration. For example, services can allow for monitoring of the printer virtual machine status and/or current state/configuration. An agent can also optionally communicate with a printer virtual machine in real-time, to thereby change the course of execution, for example, by communicating new applets (including applets insertable in a running applet). Various managers can invoke functionality on and receive results from the printer applet through an agent.

Advantages of managed printers include flexibility in functionality and communication (e.g., HTTP over TCP/IP paths and/or XML syntax), extensibility (adjust and/or add applications), and integration of current and new functionality.

Various software and/or hardware components useful in managers and/or managed printer systems and related methods or processes are described below and include virtual machines, agents, managers, and applets.

Printer Virtual Machine

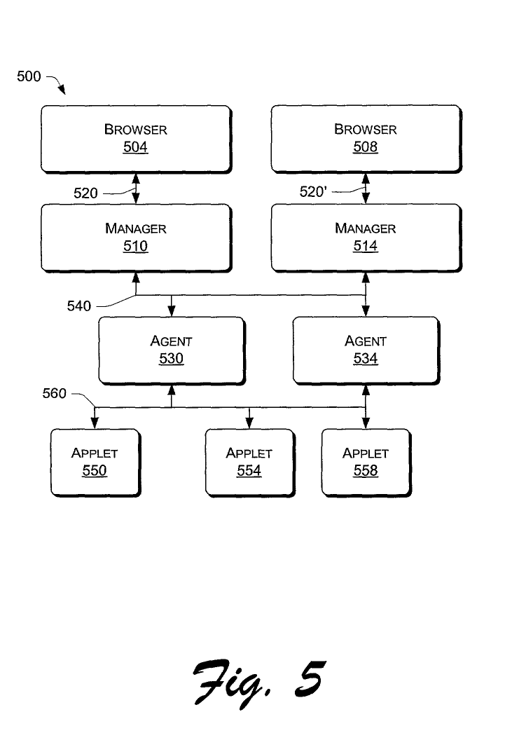

FIG. 4 shows a diagram of a printer 110 having a virtual machine 410. The printer 110 corresponds to a printer shown in FIG. 1, e.g., 110, 112. The printer 110 communicates with a network 100 via a network interface 128. Of course, other methods of communication known in the art (e.g., disk, electromagnetic, etc.) are within the scope of the printer's 110 capabilities. The virtual machine 410 uses the printer's 110 memory 124 and the processor 120 to execute code and thereby produce desired results.

As shown in FIG. 4, the virtual machine 410 includes an applet loader 414, an interpreter and/or compiler 418 and a runtime engine 422. As known in the art, a virtual machine is software that acts as an interface between a program code and a processor or hardware platform that actually performs the program's instructions. Examples of commercially available virtual machines include the JAVA™ virtual machine (Sun Microsystems, Inc., Palo Alto, Calif.); the .NET™ framework virtual machine (Microsoft Corporation, Redmond, Wash.); and the CHAI® virtual machine (Hewlett-Packard Company, Palo Alto, Calif.). Referring again to FIG. 4, the applet loader 414 loads an applet into the virtual machine 410, which relies on, for example, the printer's 110 memory 124. Next, the interpreter or compiler 418 interprets and/or compiles the applet to instructions (or native machine code) suitable for execution on the processor 120.

Applets are commonly sent to a virtual machine as a portable executable file that includes bytecode (e.g., JAVA™) or an intermediate language code (e.g., .NET™). In some instances, the PE file includes other information (e.g., metadata, management parameters, etc.) related to the applet. Further details of applets and information contained therein are described below.

Agents and/or managers may operate on a virtual machine, including, but not limited to, a printer virtual machine or other resident or remote virtual machine.

Browser-Manager-Agent-Applet Hierarchy

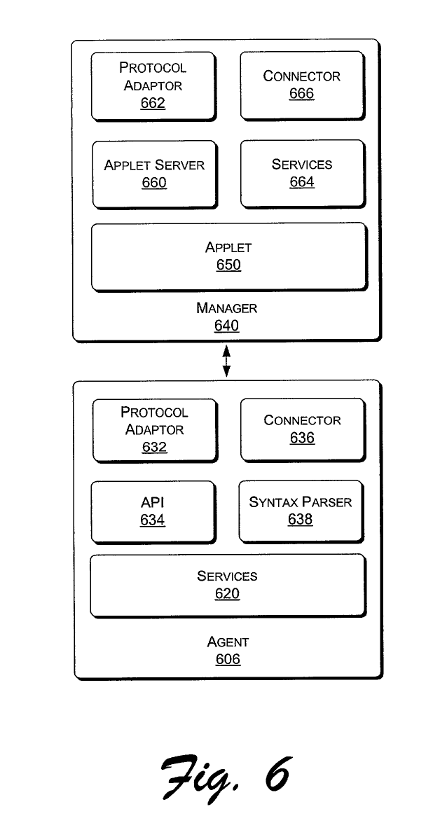

According to the systems described herein, a manager directs an applet or applets to a printer having a virtual machine, which is referred to herein as a printer virtual machine (PVM). Various sources for applets include Web sites, servers, workstations, etc. Alternatively, a manager detects the presence of an applet already resident on a printer. For example, FIG. 5 shows an exemplary hierarchy 500 that includes two browsers 504, 508; two managers 510, 514; two agents 530, 534; and three applets 550, 554, 558. Details of exemplary managers, agents and applets and various relationships between managers, agents, applets, printers, PVMs, VMs, networks, etc. are also given below.

Browsers

Referring to FIG. 5, a browser 504, 508 communicates with a manager 510, 514. In general, a browser 504, 508 comprises a software program for reading hypertext; thus, browsers are usually associated with the Internet and the World Wide Web (WWW). A browser 504, 508 may be able to access information in many formats, and through different services including HTTP, FTP, Gopher, and Archie. In FIG. 5, communication occurs through an interface 520, 520′. In one exemplary hierarchy, a manager 510, 514 and a browser 504, 508 reside on the same workstation and/or server while in another exemplary hierarchy, a manager 510, 014 resides on a workstation or server and a browser 504, 508 resides on a different workstation or server. Of course, the nature of the interface 520, 520′ may differ between these two exemplary hierarchies.

Managers and Agents

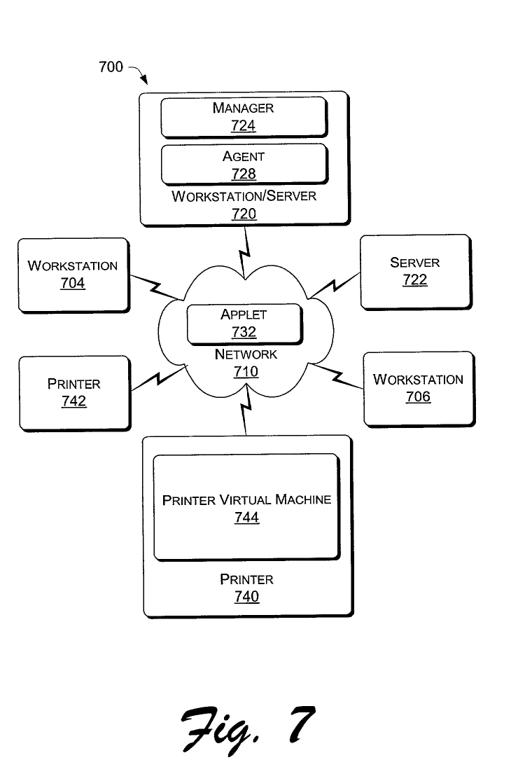

With reference to FIG. 5, a manager 510, 514 communicates with an agent 530, 534 to perform a variety of tasks. Communication typically occurs through an interface 540. FIG. 6 shows a more detailed diagram of an exemplary agent 606 and an exemplary manager 640 that are suitable for use in the hierarchy shown in FIG. 5 (e.g., 530, 534, 510, 514). The exemplary manager 640 includes an applet 650, an applet server 660, a protocol adaptor 662, services 664, and a connector 666 (e.g., connector server and/or client). The exemplary agent 606 includes a protocol adaptor 632, an API 634, a connector 636 (e.g., connector server and/or client), a syntax parser 638, and services 620.

Referring to FIG. 5, in an exemplary system, the interface 540 comprises software. For example, where a manager 510, 514 and an agent 530, 534 reside on the same computer (e.g., workstation or server), the interface 540 includes an application program interface (API) implemented by an agent 530, 534. A manager 510, 514 optionally communicates with a plurality of agents 530, 534 that use APIs. The relationship between a manager 640, an agent 606 and an API 634 is shown in FIG. 6 wherein a manager 640 and an agent 606 optionally reside on the same computer (e.g., workstation or server) and an interface includes an API 634 implemented by the agent 606.

An API 634 generally includes a formalized set of software calls and routines that can be referenced by an application program to make requests of an operating system and/or another application. Thus, referring to FIG. 5, an API (e.g. 634) can provide an interface 540 for communication between a manager 510, 514 and an agent 530, 534 that reside on the same computer. Referring again to FIG. 6, in one exemplary system, an agent 606 implements a manager specific API 634 wherein the API 634 includes a dynamic link library (DLL). A DLL typically includes a collection of programs, which are called on an as-needed basis by another program running on the computer. For example, an agent 606 optionally calls a program from an API 634 DLL to provide for communication between the agent 606 and a manager 640. Alternatively, or in addition to, an API 634 allows for communication between agents 530, 534 such as those shown in FIG. 5.

When a manager 510, 514 and an agent 530, 534 reside on different computers, referred to herein as a “remote” manager, the interface optionally includes connectors and/or adaptors. In an exemplary system, shown in FIG. 6, an interface includes connectors 636, 666 and/or adapters 632, 662. In this exemplary system, an optionally remote manager 640 uses a connector interface 636, 666 to communicate with an agent 606 transparently through a network. In another instance, the optionally remote manager 640 and/or agent 606 use an interface that includes at least one protocol adapter 632, 662 that uses, for example, Transmission Control Protocol/Internet Protocol (TCP/IP) and Hypertext Transfer Protocol (HTTP). TCP/IP is a basic communication language or protocol of the Internet and can also be used as a communications protocol in a private network (either an intranet or an extranet).

A remote manager may also use a Simple Network Management Protocol (SNMP) to communicate with an agent. SNMP is the Transmission Control Protocol/Internet Protocol (TCP/IP) standard protocol that is used to manage and control IP gateways and the networks to which they are attached.

Referring again to FIG. 5, in instances where a manager 510, 514 communicates with an agent 530, 534 via an interface 540 using a protocol adapter (e.g., 632, 662), the protocol adapter provides for communication through a given protocol. FIG. 6 shows such an optional manager 640 and agent 606 arrangement wherein at least one protocol adaptor 632, 662 adapts information into a representation in the given protocol, and possibly into a different information model. The adapted information is then available for communication to the manager 640 and/or agent 606.

In instances where a manager 510, 514 communicates with an agent 530, 534 via a connector interface 540, an agent 530, 534 optionally includes a connector server (e.g., 636) and the manager optionally includes a connector client (e.g., 666). FIG. 6 shows such an optional manager 640 and agent 606 arrangement wherein a connector server 636 and a connector client 666 communicate using a protocol. Further, the connector interface is optionally protocol specific.

In one exemplary system, a manager 510, 514 can communicate with at least one agent 530, 534 via at least one connector client, at least one connector server and/or least one protocol adaptor.

In an exemplary system, a manager serves and/or directs an applet to a device having a virtual machine installed thereon. As shown in FIG. 6, a manager 640 has an associated applet 650 which is further associated with an agent 606. The manager 640 optionally uses an applet server 660 to serve the applet 650 to a printer having a virtual machine. Alternatively, a manager directs an applet directly from a remote location (e.g., a Web site) to a printer.

In general, a manager manages applets through communication with an agent. Referring again to FIG. 6, in an exemplary system, a manager 640 includes services 664. The manager 640 uses a communication interface (e.g., API, connector and/or adaptor) to manage at least one applet. Management services 664 optionally include monitoring attributes, getting attribute values, setting or changing attribute values, invoking operations, etc. Attribute values include arguments, results, notifications, etc. Exemplary operations include implementing management policies, instantiating applets, registering applets, launching applets, starting execution, stopping execution, and expiring processes and/or attributes. The manager 640 optionally performs a variety of other tasks.

A manager farther optionally includes a Web browser and/or a plug-in. Resident managers and/or remote managers are within the scope of the managers described herein. A resident manager normally resides on a device having a manageable agent thereon. A remote manager normally resides on a device separate from and in communication with the device on which the agent resides. A manager resides in hardware and/or in software on a device having a processor and memory. A manager may reside on a device having a virtual machine.

Agents-Applets

As shown in FIG. 5, an agent 530, 534 typically communicates with applets 550, 554, 558. Often, an agent is associated with a specific applet thereby forming an agent-applet pair. FIG. 6 shows a more detailed diagram of an exemplary agent 606 suitable for use in the hierarchy shown in FIG. 5 (e.g., 530, 534). The agent 606 shown in FIG. 6 includes a protocol adaptor 632, an API 634, a connector server 636, a syntax parser 638, and services 620.

An applet (e.g., 550, 554, 558 shown in FIG. 5 or 650 shown in FIG. 6) generally comprises a small, self-contained computer program that performs a task or tasks as part of, or under the control of, a larger software application. For example, most modern World Wide Web browsers are capable of making use of applets written in the JAVA™ programming language to perform simple tasks such as displaying animations or more complex tasks such as operating spreadsheets and/or databases. A chailet is another form of applet. More specifically, chailets are JAVA™ programs that run on a CHAI® VM to carry out specific functions, such as performing computations based on the input from a remote device or sending a notification. A CHAI® VM optionally cooperates with a CHAI® server and/or CHAI® services. In one exemplary system, a remote agent communicates with a printer having a CHAI® VM capable of executing a chailet. In particular, the agent has the ability to control execution of the chailet and to receive information germane to and/or resulting from chailet execution. An agent may also communicate with more than one printer wherein each printer has an applet (e.g., a chailet) and a VM capable of executing the applet. In one exemplary system, a single agent communicates with a plurality of printers wherein each printer has a copy of the same applet.

As already mentioned, an applet server 660 can transmit an applet 650 to an applet “client”, such as, but not limited to, a printer (e.g., printer 110 of FIG. 4), or more specifically, a PVM (e.g., PVM 410 of FIG. 4). In an exemplary system, a manager loads an applet on a device having controllable resources, in particular, resources that an applet can control.

As shown in FIG. 6, an agent 606 includes a syntax parser 638 to provide for communication with an applet. An agent 606 also optionally includes a set of services 620 for performing tasks related to an applet and/or a manager. In an exemplary system, agent services 620 include objects that can perform management operations on applets. Of course, such agent service objects may also include applets. Agent services 620 include, but are not limited to, dynamic loaders (argument, argument value, applet, class, library, etc.) applet monitors, timers, syntax parsers, adaptors, connectors, and relation services to define associations between applets.

Regarding agent-applet communication, as shown in FIG. 6, an agent includes at least one interface having, for example, an adaptor 632, a connector 636, and/or a syntax parser 638. The adaptor 632 and connector 636 generally operate as described above; however, now allowing for communication with a device having a VM. The agent 606 further includes a syntax parser 638, which typically receives input in the form of sequential source program instructions, interactive online commands, markup tags, or some other defined interface and breaks them up into parts. For example, syntax parser 638 optionally parses information in an extensible markup language (XML).

In one exemplary system, an agent includes a dynamic loading service or a dynamic loader. The dynamic loader allows for instantiation and/or registration of applets from a remote site, either or both of which are optionally identified and accessed through an URL. In this exemplary system, information on the applets at the remote site is optionally specified in XML. The XML may be contained in a file that specifies arguments, argument values, applets, classes, libraries, etc. In an alternative system, a manager includes a dynamic loader while in yet another exemplary system, a device having a VM installed thereon includes a dynamic loader.

Application Plug-In

Application plug-ins or plug-in applications are programs that are easily installed and used typically to extend the functionality of another application. In one exemplary system, an application plug-in includes a manager, an agent, and an applet. In this exemplary system, the manager, the agent and the applet load, run and manage a printer application. In another exemplary system, an application plug-in includes an agent and an applet that work cooperatively with or without a manager. Often, an application plug-in works cooperatively with a browser such as a Web browser. A variety of exemplary systems, some of which are suitable for implementation as plug-ins, are presented below.

Printer for Receiving and Running Applets

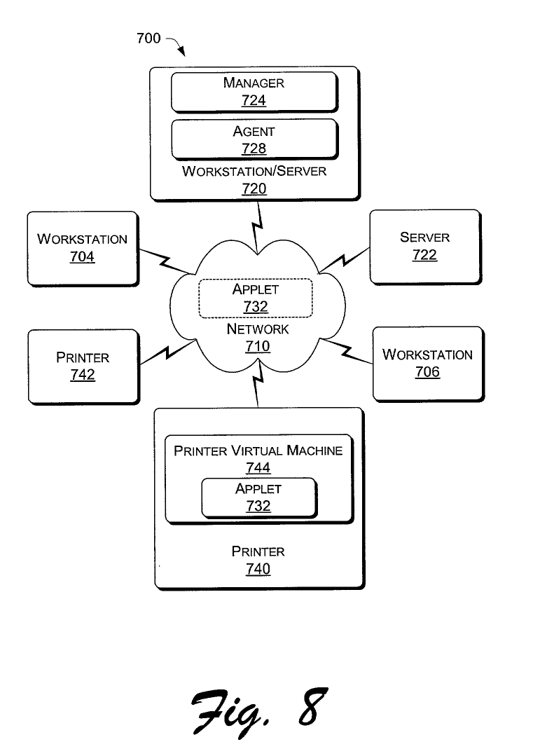

FIGS. 7, 8 and 9 show an exemplary system 700 that includes a printer 740 for receiving and running an applet 732. As shown in FIG. 7, a workstation and/or server 720 and a printer 740 having a PVM 744 connect to a network 710. Additional printers 742, workstations 704, 706 and/or servers 722 optionally connect to the network 710. The workstation/server 720 includes a manager 724 and an agent 728 wherein the manager 724 and the agent 728 communicate via an API, an adapter and/or a connector. The agent 728 is associated with at least one applet 732. In this exemplary system 700, the manager 724 and the agent 728 reside on the workstation/server 720.

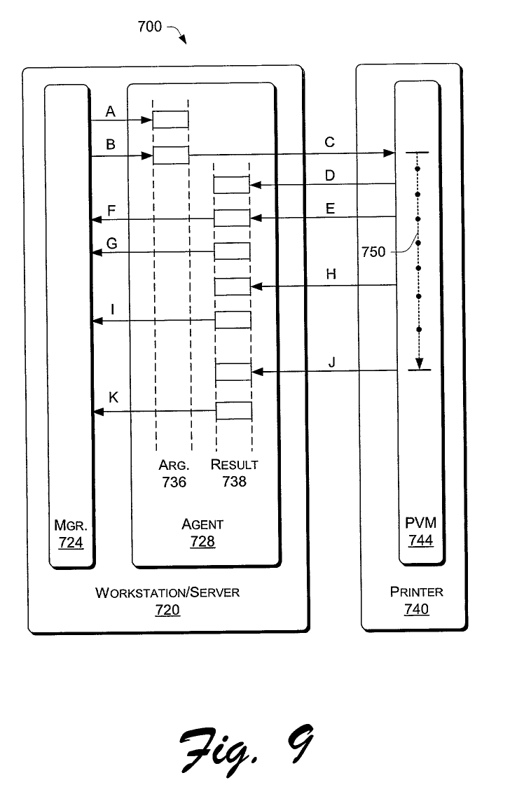

Referring to FIG. 8, the manager 724 serves and/or directs (e.g., makes available or sends) the applet 732 via the network 710 to the printer 740 wherein the PVM 744 can load the applet 732. Once the applet 732 resides in the printer's memory, a variety of operations may follow.

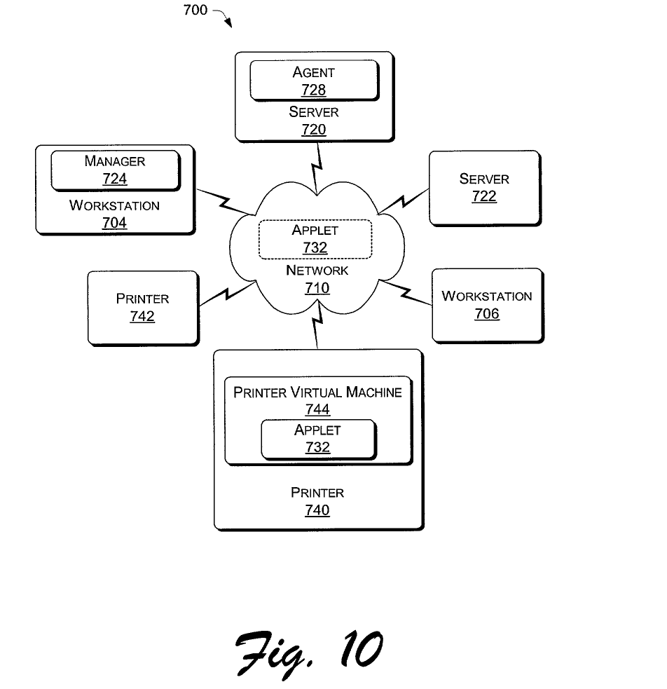

FIG. 9 shows a variety of exemplary operations or events, labeled A through K, performed using the system 700 of FIGS. 7 and 8. The events occur over a period of time in a sequential order, events communicated to the PVM 744 are represented in part by a PVM event line 750, which appears for purposes of illustration only. The PVM event line 750 corresponds generally to execution of an applet (e.g., 732 of FIGS. 7 and 8). To further illustrate the various operations, an agent argument holder or register 736 and an agent result holder or register 738 are also shown.

Event A corresponds to the manager 724 communicating an argument value to the agent 728 wherein the agent 728 places the value in the argument holder 736. Event B corresponds to the manager 724 communicating a command argument value to the agent 728 wherein the agent 728 places the value in the argument holder 736. Event B optionally includes a “launch applet” command, which the agent 728 communicates to the PVM 744, represented as Event C. Event C causes the PVM 744 to start running the applet.

Event D follows Event C wherein the PVM 744 or printer 740 communicates a result value (e.g., an intermediate result value) to the agent 728, which the agent places it in the result holder 738. The particular result value of Event D may be of little interest to the manager 724; thus, it may simply reside in the agent 728 until needed, if needed at all.

Event E represents another result value communicated from the PVM 744 or printer 740 to the agent 728, wherein the agent 728 places it in the result holder 738. In this instance, the result value is of interest to the manager 724 and hence the value is communicated from the agent 728 to the manager 724, as represented by Event F.

Event G follows Event F wherein a notification is communicated from the agent 728 to the manager 724. The notification optionally corresponds to a PVM operation, an applet operation, an agent operation, and/or a manager operation. For example, the agent 728 may include agent services that notify the manager 724 whenever a particular type of result or result value is received from the printer 740 or PVM 744.

Event H corresponds to a notification communicated from the printer 740 or PVM 744 to the agent 728. The notification optionally includes a result value for placement into the result holder 738. The printer 740, PVM 744, manager 724 and/or the agent may require that this result value be communicated from the agent 728 to the manager 724. The communication of this notification (Event H) from the agent 728 to the manager 724 corresponds to Event I.

Referring to the bottom end of event line 750, Event J corresponds to communication of a final result value from the printer 740 or PVM 744 to the agent 728. Event J may also coincide with termination of the applet's run on the PVM 744. Event K corresponds to communication of the final result value from the result holder 738 of the agent 728 to the manager 724.

Note that in FIG. 9, the form of communication between the printer 740 or the PVM 744 and the agent 728 is not specified; thus, communication occurs through a variety methods and/or devices such as those disclosed herein (e.g., a network, a connector, a syntax parser, an adaptor, etc.). Also, the form of communication between the agent 728 and the manager 724 is not specified; thus, communication occurs through a variety of methods and/or devices such as those disclosed herein (e.g., APIs, adapters, and/or connectors).

Printer for Receiving and Running Agents and Applets

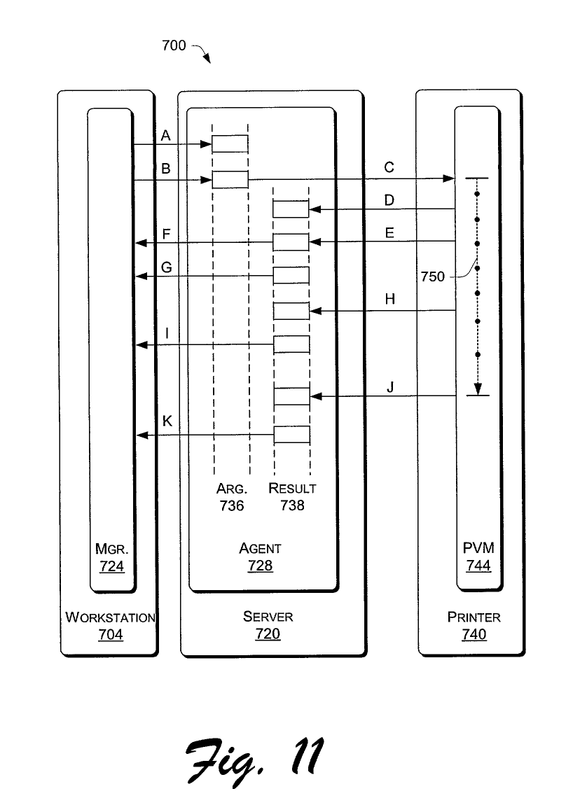

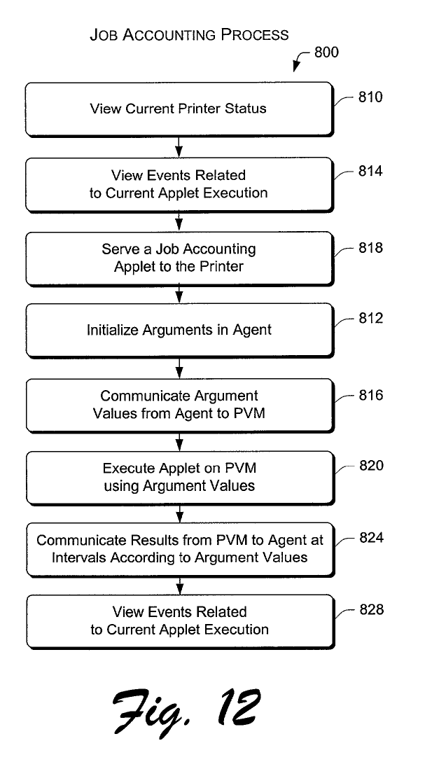

FIGS. 10 and 11 show an exemplary system 700 that includes a printer 740 for receiving and running an applet 732. As shown in FIG. 10, a workstation 704 having a manager 724, a server 720 having an agent 728 and a printer 740 having a PVM 744 connect to a network 710. Additional printers 742, workstations 706 and/or servers 722 optionally connect to the network 710. The workstation 704 manager 724 and the server 720 agent 728 communicate via network 710 using at least one adapter and/or connector. In this exemplary system 700, the applet 732 initially resides on the network 710 (e.g., at a workstation and/or server) and is subsequently communicated to the printer 740.

Referring to FIG. 10, the workstation 704 manager 724 serves (e.g., makes available or sends) the applet 732 via the network 710 to the printer 740, wherein the PVM 744 can load the applet 732. Once the applet 732 resides in the printer's memory, a variety of operations may follow.

FIG. 11 shows a variety of exemplary operations or events, labeled A through K, performed using the system 700 of FIG. 10. The events occur over a period of time in a sequential order, events communicated to the PVM 744 are represented in part by a PVM event line 750, which appears for purposes of illustration only. The PVM event line 750 corresponds generally to execution of an applet (e.g., 732 of FIG. 10). To further illustrate the various operations, an agent argument holder or register 736 and an agent result holder or register 738 are also shown. Note, that as shown in FIG. 10, the manager 724 resides on a workstation 704 and the agent 728 resides on a server 720; thus, the manager 724 may be classified as a remote manager.

Event A corresponds to the manager 724 communicating an argument value to the agent 728 wherein the agent 728 places the value in the argument holder 736. Event B corresponds to the manager 724 communicating a command argument value to the agent 728 wherein the agent 728 places the value in the argument holder 736. Event B optionally includes a “launch applet” command, which the agent 728 communicates to the PVM 744, represented as Event C. Event C causes the PVM 744 to start running the applet.

Event D follows Event C wherein the PVM 744 communicates a result value (e.g., an intermediate result value) to the agent 728, which the agent places it in the result holder 738. The particular result value of Event D may be of little interest to the manager 724; thus, it may simply reside in the agent 728 until needed, if needed at all.

Event E represents another result value communicated from the PVM 744 to the agent 728, wherein the agent 728 places it in the result holder 738. In this instance, the result value is of interest to the manager 724 and hence the value is communicated from the agent 728 to the manager 724, as represented by Event F.

Event G follows Event F wherein a notification is communicated from the agent 728 to the manager 724. The notification optionally corresponds to a PVM operation, an applet operation, an agent operation, and/or a manager operation. For example, the agent 728 may include agent services that notify the manager 724 whenever a particular type of result or result value is received from the printer 740 or the PVM 744.

Event H corresponds to a notification communicated from the PVM 744 to the agent 728. The notification optionally includes a result value for placement into the result holder 738. The printer 740, PVM 744, manager 724 and/or the agent may require that this result value be communicated from the agent 828 to the manager 724. The communication of this notification (Event H) from the agent 728 to the manager 724 corresponds to Event I.

Referring to the bottom end of event line 750, Event J corresponds to communication of a final result value from the PVM 744 to the agent 728. Event J may also coincide with termination of the applet's run on the PVM 744. Event K corresponds to communication of the final result value from the result holder 738 of the agent 728 to the manager 724.

Note that in FIG. 11, the form of communication between the printer 740 or the PVM 744 and the agent 728 is not specified; thus, communication occurs through a variety methods and/or devices such as those disclosed herein (e.g., a network, a connector, a syntax parser, an adaptor, etc.). Also, the form of communication between the agent 728 and the manager 724 is not specified; thus, communication occurs through a variety methods and/or devices such as those disclosed herein (e.g., adapters and/or connectors).

Exemplary Events or Operations

The events and/or operations represented by Events A through K in FIGS. 9 and 11 correspond to events and/or operations typically used in printers. For example, exemplary events and/or operations related to ink volume; paper volume; fonts; security; format; resolution; paper jams; diagnostics; repair; reporting; billing; accounting; alerting; embedding; Web server configuring; setting printer configurations; optical detection and/or testing. These events and/or operations optionally correspond to manager and/or agent commands and applets loaded on a VM(s). For example, management events and/or operations (e.g., initiated by a manager and/or an agent) optionally include listing of applets running on a VM, determining the amount of memory allocated to and/or used by each applet and/or a VM, determining the amount of memory available to a VM, determining the amount of memory storage space used by an applet and/or a VM, and determining applet management parameters (e.g., setting and/or reading) such as applet identification, version, author and/or provider, support contact information (e.g., company support, URL, phone number, etc.). Of course, a manager and/or an agent optionally run on a VM or VMs.

In the flow diagram of FIG. 12, various algorithmic acts are summarized in individual “blocks”. Such blocks describe specific actions or decisions that are made or carried out as a method or process proceeds. Where a processor is employed, the flow charts presented herein provide a basis for a “control program” or software/firmware that may be used by such a processor (or equivalent) to effectuate the desired method. As such, the methods or processes are implementable as machine-readable instructions stored in memory that, when executed by a processor, perform the various acts illustrated as blocks. Those skilled in the art may readily write such a control program based on the flow charts and other descriptions presented herein. Software to program the processors and, additionally, any and all computer-readable media on which such software might be embodied are within the scope of this disclosure. Examples of such computer-readable media include, without limitation, floppy disks, hard disks, CDs, RAM, ROM, flash memory and the like.

Referring to FIG. 12, a print job accounting process 800 is shown. In a view block 810 an administrator views the current status of a printer using, for example, a manager and an agent resident on a workstation and remote from the printer. In an applet execution view block 814, the administrator uses the manager and agent to view events related to execution of an applet or applets currently running on the printer's PVM. In response to printer status and/or events related applet execution, a serve block 818 serves a job accounting applet or applets to the printer. An initialize block 812 initializes arguments in the agent, which is accomplished, for example, through use of the manager. A communication block 816 communicates argument values from the agent to the PVM. An execute block 820 executes or runs the applet on the PVM wherein the executed applet uses argument values set in the initialize block 812. Another communication block 824 communicates results from the PVM to the agent at, for example, intervals according to argument values. Throughout execution, a view block, e.g., view block 828, allows viewing of events related to current applet execution. This exemplary process 800 optionally prepares a report for further communication and/or action.

Conclusion

The systems and/or methods disclosed herein are suitable for a variety of applications. Such applications include, but are not limited to: E-commerce solutions that integrate imaging and printing with enterprise/service provider business processes; hardcopy solutions that integrate imaging and printing processes and provide building blocks for E-commerce solutions (e.g., E-Publishing, consumables/usage management (including sensors), peripheral management, overall system/data/job/network management/flow/security, document/job management, media/finishing management, media finishing hardware, color management, connectivity solutions, user interfaces, Casper); Internet centric architecture (e.g., performance, imaging and printing (I&P) solution infrastructure, I&P spoolers, virtual personal printer, digital send “like” technologies, JetSend “like” technologies, wireless, other new forms of connectivity, home networking); and service and support (e.g., remote diagnostics (including sensors), predictive maintenance, consumables management, call center enhancements).

Although the invention has been described in language specific to structural features and/or methodological steps, it is to be understood that the invention defined in the appended claims is not necessarily limited to the specific features or steps described. Rather, the specific features and blocks are disclosed as preferred forms of implementing the claimed invention.

1. A manager loadable printer.

2. The printer of claim 1 loadable with an applet served by a manager.

3. The printer of claim 1 loadable with an applet served by a manager and further comprising a virtual machine capable of executing the applet.

4. The printer of claim 1 further comprising an interface for communication with an agent.

5. The printer of claim 1 loadable with an applet comprising printer instructions.

6. A method of instructing a printer having a virtual machine, the method comprising:
providing an agent, the agent having an associated applet;
loading the applet on the virtual machine; and
executing the applet on the virtual machine.

7. The method of claim 6 further comprising communicating the executing to the agent.

8. The method of claim 7 further comprising communicating from the agent to a manager.

9. The method of claim 6 wherein the applet includes print job accounting instructions.

10. The method of claim 6 wherein the executing includes print job accounting.

11. The method of claim 6 wherein the loading includes serving an applet to a printer via a network.

12. The method of claim 11 wherein the network includes the Internet.

13. The method of claim 6 wherein the providing includes loading the agent on a workstation.

14. The method of claim 6 wherein the providing includes loading the agent on a server.

15. The method of claim 6 wherein the agent executes on a virtual machine.

16. The method of claim 6 wherein the applet includes an instruction selected from the group consisting of alerting, embedding, configuring, setting, and combinations thereof.

17. A printer comprising:
an applet
a virtual machine capable of executing the applet; and
an interface for communication between the printer and a remote agent.

18. The printer of claim 17 wherein the interface comprises a protocol adaptor.

19. The printer of claim 17 wherein the interface comprises a connector.

20. The printer of claim 17 wherein the interface comprises a syntax and a syntax parser.

21. The printer of claim 17 wherein the interface comprises XML and an XML parser.

22. The printer of claim 17 wherein the interface comprises TCP/IP.

23. The printer of claim 17 wherein the agent communicates with a manager.

24. The printer of claim 17 wherein the applet includes printer instructions.

25. A method of instructing a printer having a virtual machine comprising:
serving an applet to the printer;
executing the applet on the virtual machine to produce a result;
communicating the result from the printer to an agent; and
communicating the result from the agent to a manager.

26. The method of claim 25 wherein the serving includes loading the applet into memory on the printer.

27. The method of claim 25 further comprising initiating the executing via a manager and the agent.

28. The method of claim 25 further comprising communicating arguments from a manager to the agent

29. The method of claim 25 wherein the communicating from the printer to the agent includes communicating via a network.

30. The method of claim 25 wherein the serving includes serving an applet to a plurality of printers each having a virtual machine.

31. A computer-readable medium containing a computer program that is storable in memory and executable by a processor to configure a printer and at least one computer to perform the method of claim 25.

32. A printer comprising:
an applet execution means for executing the applet; and
interface means for communicating between the printer and a remote agent.

33. The printer of claim 32 wherein the interface means comprises a syntax and a syntax parser.

34. The printer of claim 32 wherein the interface means comprises XML and an XML parser.

34. The printer of claim 32 wherein the interface means comprises TCP/IP.

35. The printer of claim 32 wherein the agent communicates with a manager.

36. The printer of claim 32 wherein the applet includes printer instructions.
